(19) United States
(12) Patent Application Publication
(10) Pub. No.: US 2010/0237850 A1
(43) Pub. Date: Sep. 23, 2010

(54) Device and method for testing food quality

(76) Inventors: Ahmed Abdullah Salem Al-Ghamdi, Jeddah (SA); Fahad M. Al-Marzouki, Jeddah (SA); Soliman Abdalla, Roushdi-SidiGaber (EG)

Correspondence Address: LITMAN LAW OFFICES, LTD., POST OFFICE BOX 41200, SOUTH STATION, ARLINGTON, VA, 22204, US

(21) Appl. No.: 12/382,616

(22) Filed: Mar. 19, 2009

(51) Int. Cl. G01N 27/00

(52) U.S. Cl. 324/72

(57) ABSTRACT

The device for testing food quality is a device for measuring the state of decay of a piece of food based upon measured electrical potential. The device includes a needle probe having an outer cylindrical shell formed from a first metal, such as stainless steel, and a wire mounted coaxially within the outer cylindrical shell. The wire is formed from a second metal, such as copper. A measuring device for electrical potential, such as a voltmeter, is further provided and is in communication with the needle probe. The device forms a galvanic cell when the probe is inserted into the food, the cell potential decreasing as a function of time in a manner corresponding to the state of decay of the piece of the food.

### BACKGROUND OF THE INVENTION

1. Field of the Invention

The present invention relates to food management, and particularly to a device and method for testing food quality that assesses the state of decay of a piece of food based upon measurement of electrical potential.

2. Description of the Related Art

Food poisoning can cause serious illness, or even lead to death. Even in technologically modern parts of the world, where store bought food is expected to be fresh and sanitary, decayed or otherwise tainted meat, poultry or the like can be easily missed during quality control, or disguised due to packaging. Various types of testers and indicators for food quality are known, however such testers (such as color-changing strips fixed to the food packaging, for example) tend to be expensive to produce and relatively difficult to use and read. Thus, a device and method for testing food quality solving the aforementioned problems is desired.

### SUMMARY OF THE INVENTION

The device for testing food quality assesses the state of decay of a piece of food based upon measurement electrical potential. The device includes a needle probe having an outer cylindrical shell formed from a first metal, such as stainless steel, and a wire mounted coaxially within the outer cylindrical shell. The wire is formed from a second metal, such as copper.

The needle probe is connected to a potentiometer or voltmeter for measuring electrical potential. The measured electrical potential for the resulting galvanic cell represents a state of decay of the piece of the food.

These and other features of the present invention will become readily apparent upon further review of the following specification and drawings.

### BRIEF DESCRIPTION OF THE DRAWINGS

FIG. 1 is an environmental, perspective view of a device for testing food quality according to the present invention.

FIG. 2 is a partial, perspective view of a needle probe of the device for testing food quality according to the present invention, the probe being broken away and partially in section.

FIG. 3 is an exemplary graph showing measured cell electrical potential as a function of time for a sample piece of meat using the device and method for testing food quality according to the present invention.

FIG. 4 is an exemplary graph showing measured cell electrical potential as a function of time for a sample piece of fish using the device and method for testing food quality according to the present invention.

### DETAILED DESCRIPTION OF THE PREFERRED EMBODIMENTS

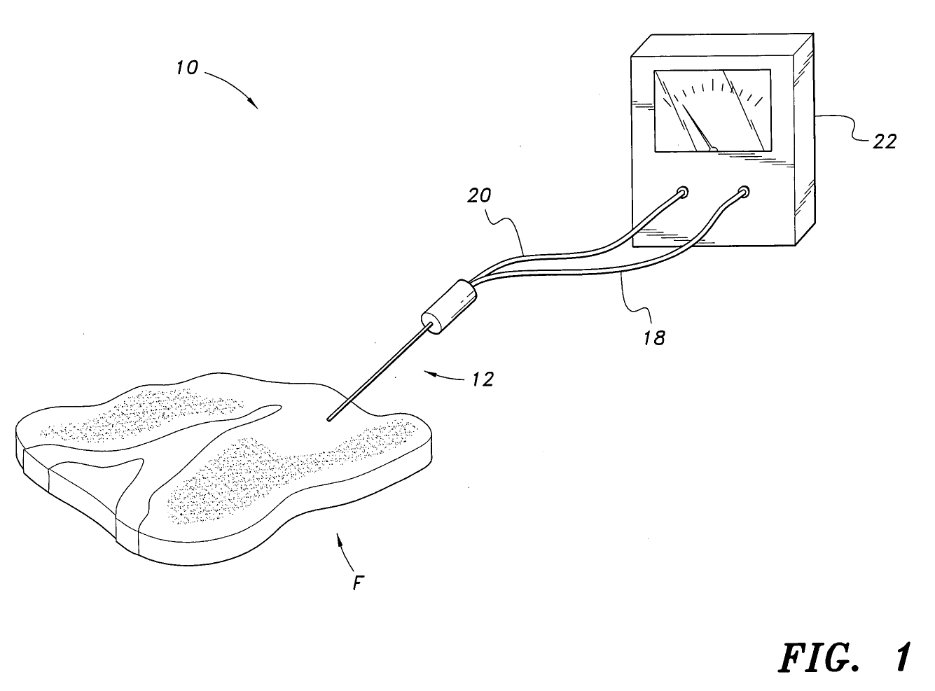

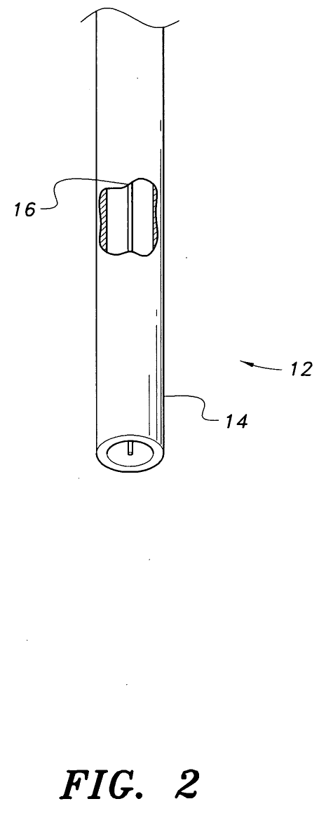

As shown in FIGS. 1 and 2, the device 10 for testing food quality 10 includes a needle probe 12 connected to a voltmeter 22 via leads 18, 20. As best shown in FIG. 2, the needle probe 12 is a coaxial needle, having an outer cylindrical shell 14 and an inner wire 16 mounted coaxially therein. Outer shell 14 and inner wire 16 are formed from different metals. Preferably, the inner wire 16 is formed from copper and the coaxial outer shell 14 is formed from stainless steel. The metals selected for inner wire 16 and outer wire 14 are preferably non-toxic, since needle probe 12, as shown in FIG. 1, is inserted into a piece of food F to be tested.

In FIG. 1, an exemplary piece of meat is illustrated as tested food F, although it should be understood that device 10 may be used with any desired type of food to be tested. Upon insertion of the needle probe 12 into food F, fluids within food F act as an electrolytic solution, thus generating a measurable potential difference between inner wire 16 and outer shell 14 of needle probe 12. Inner wire 16 is connected to one input of a voltmeter 22 via lead 20, and outer shell 14 is connected to a second input of voltmeter 22 via lead 18, which may be conventional wires or the like, and the voltage generated by the tested food F is measured on voltmeter 22. It should be understood that voltmeter 22 is shown for exemplary purposes only, and that any suitable voltmeter, potentiometer, or the like may be used to measure the potential difference between inner wire 16 and outer shell 14.

As will be described in detail below, voltage generated through the metal-food contact (i.e., the potential described above) provides a first, measurable source of potential. However the decay of organic matter (meat, for example) creates complex, electrochemical reactions, with the decay process itself generating a measurable potential (i.e., the potential generated by the decay alone, rather than the first process of metal-food reactions).

Although shown in simplified form in FIG. 1, it should be understood that any arrangement of probe 12 and voltmeter 22 may be used. For example, voltmeter 22 and probe 12 may be incorporated into a single, handheld body. Needle probe 12 is relatively small so that damage the food to be tested does not occur. Outer shell 14 may have a diameter of approximately 0.4 mm, for example. Inner wire 16 may have a diameter of approximately 0.2 mm, for example.

In use, the inner wire 16 and outer shell 14 of needle probe 12 are embedded in the food sample F to a depth of approximately one cm. The area being tested in food sample F is approximately 0.225 cm² (based on the exemplary dimensions given above). The material being tested is the food sample sandwiched between inner wire 16 and outer shell 14. Device 10 measures a continuous electrical potential decay V_{intinsic}, with respect to time, t. It should be understood that needle probe 12 represents a preferred configuration of inner wire 16 and outer shell 14. However any desired configuration may be utilized, includes separating the inner wire 16 and outer shell 14 to form two separate probes.

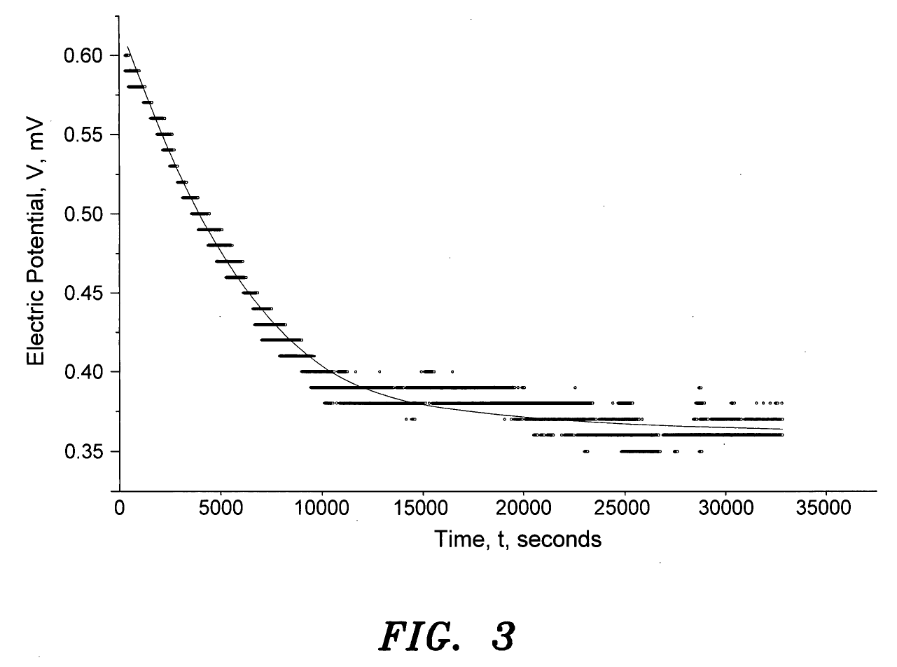

FIG. 3 illustrates a data plot for an exemplary piece of meat, tested with device 10. Measured galvanic electrical potential V is shown measured in mV as a function of time, measured in seconds. At initial time t=0, the curve starts at 600 mV, then decreases regularly with time to a measured V of 360 mV at 3.2×10⁴ seconds. Fitting a curve to the measured data yields a measured exponential decreasing rate of λ=1.7×10⁻⁴ mV/s.

The exponential decay of measured electrical potential is explained through consideration of two different potentials being measured within the food sample F. The first potential is attributed to the metal-meat contact and reaction. This first potential is hereinafter represented as V_{contacts}. The second potential, as noted above, is the “intrinsic” potential of the decaying food; i.e., potential measured solely from the complex electrochemical reactions of the decay process itself. This intrinsic potential, V_{intrinsic} is combined with V_{contacts} to produce the overall measured potential V, i.e., V=V_{contacts}+V_{intrinsic}.

The inventors have noticed that intrinsic has an exponential decaying nature. Thus, the measured galvanic cell potential V is given by V=V_{contacts}+Vₒ exp(−λt), where λ is the time decay constant of V_{intrinsic} and Vₒ is the initial value of V_{intrinsic} at time t=0.

The best fit curve of the experimental results shown in FIG. 3 yields a result of V_{contacts}=0.357 volts, Vₒ=0.252 volts and λ=1.7×10⁻⁴ mV/s. Thus, the potential due to meat tissue itself is 0.25 exp(−1.7×10⁻⁴ t) volts, i.e., initially at t=0, the intrinsic potential is 0.25 volts. Half of this value is denoted as V_{1/2}, which is 0.126 volts. In FIG. 3, the corresponding measured time is given as t_{1/2}=4,077 seconds. However, the measured potential at t_{1/2} is given, from FIG. 3, as 0.49 volts. This value fits the sum of both the constant potential due to the metal contacts, V_{contacts}=0.357 volts, and the calculated intrinsic potential coming from the sample meat tissue, V_{intrinsic}=0.133 volts. From the data of FIG. 3, it is concluded that meat starts to go “bad” (i.e., decays to an inedible state) after 50,000 s.

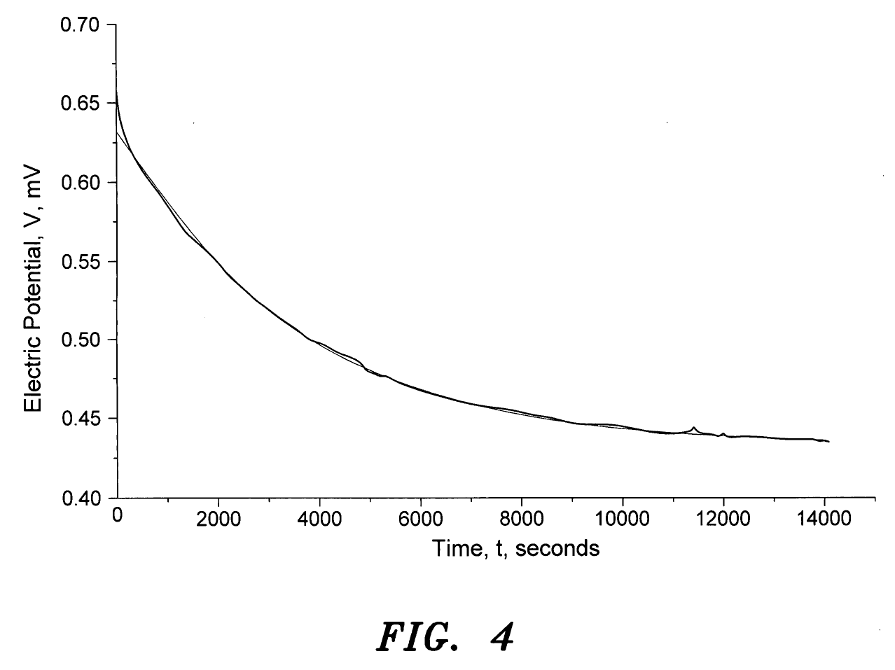

FIG. 4 illustrates testing of an exemplary piece of fish. The measurements and interpretations are similar to that described above for the exemplary meat of FIG. 3. In FIG. 4, the plotted curve starts at 657 mV, then decreases regularly with time to a V of 430 mV at time 1.4×10⁴ seconds, with an exponential decreasing rate of 2×10⁻⁴ mV/s. From the best fit curve, V_{contacts} is measured as 0.43 volts, Vₒ=0.20 volts and λ=2.0×10⁻⁴ mV/s.

The intrinsic potential of the fish sample is found to be V_{intrinsic}=0.2 exp(−2×10⁻⁴ volts. Initially, this potential is calculated as V_{intrinsic}(0)=0.2 volts. From FIG. 4, the measured value at t_{1/2}=3480 seconds is 0.53 volts. This value fits the sum of V_{contacts}+V_{intrinsic}=0.43+0.1=0.53 volts. Thus, from the data plot of FIG. 4, it is concluded that the fish sample goes “bad” after 6,000 sec. Using such experimental data, a comparison chart or other set of data may be established. A piece of food may be tested to find the electrical potential difference between the inner wire 16 and outer shield 14 inserted into the food, and the measured voltage may then be compared to the previously established data to determine the state of decay of the food being tested.

The device 10 may be used to test either packaged food (with the needle probe 12 piercing the packaging) or to test unpackaged food. Additionally, the device 10 may be packaged with the food, either with the needle probe 12 being stored separately from the food, or with the needle probe 12 inserted in the food, thus providing a visual indication of the food quality at the point of purchase. It should be understood that the meat and fish of FIGS. 3 and 4 are presented as examples only, and that device 10 may be used to test the quality of any type of food, such as, for example, fresh red meat, fish, frozen red meat, poultry, processed meat products, seafood or the like.

It is to be understood that the present invention is not limited to the embodiment described above, but encompasses any and all embodiments within the scope of the following claims.

I claim:

1. A device for testing food quality, comprising:
a needle probe having a first electrode formed as an outer cylindrical shell and a second electrode formed by a wire mounted coaxially within the outer cylindrical shell, the first and second electrodes being formed from different metals; and
means for measuring electrical potential electrically connected to the first and second electrodes, the needle probe being adapted for insertion into an article food with the first and second electrodes penetrating into and spaced apart in the food, the measured electrical potential between the electrodes corresponding to a state of decay of the food.

2. The device for testing food quality as recited in claim 1, wherein said wire is formed from copper.

3. The device for testing food quality as recited in claim 2, wherein the outer cylindrical shell is formed from stainless steel.

4. The device for testing food quality as recited in claim 1, wherein the outer cylindrical shell has a diameter of approximately 0.4 mm.

5. The device for testing food quality as recited in claim 4, wherein the wire has a diameter of approximately 0.2 mm.

6. The device for testing food quality as recited in claim 1, wherein said means for measuring electrical potential comprises a voltmeter.

7. A method of testing food quality, comprising the steps of:
inserting first and second electrodes into an article of food to be tested, the electrodes being made from dissimilar metals;
measuring an electrical potential difference between the electrodes; and
determining a state of decay of the food based upon the measured electrical potential difference.

8. The method of testing food quality as recited in claim 7, wherein said step of determining the state of decay of the food includes comparing the measured electrical potential difference with previously established reference data regarding states of food decay.

9. A device for testing food quality, comprising:
a needle probe having a first electrode formed as an outer cylindrical shell and a second electrode formed by a wire mounted coaxially within the outer cylindrical shell, the first and second electrodes being formed from different metals; and
a voltmeter electrically connected to the first and second electrodes, the needle probe being adapted for insertion into an article food with the first and second electrodes penetrating into and spaced apart in the food, the measured voltage between the electrodes corresponding to a state of decay of the food.

10. The device for testing food quality as recited in claim 9, wherein said wire is formed from copper.

11. The device for testing food quality as recited in claim 10, wherein the outer cylindrical shell is formed from stainless steel.
